(19) United States
(12) Patent Application Publication
(10) Pub. No.: US 2008/0136662 A1
(43) Pub. Date: Jun. 12, 2008

(54) System and Method for Activating a Mobile Device

(76) Inventors: David Bellows, Wantagh, NY (US); Thomas Wulff, North Patchogue, NY (US)

Correspondence Address: FAY KAPLUN & MARCIN, LLP, 150 BROADWAY, SUITE 702, NEW YORK, NY, 10038, US

(21) Appl. No.: 11/567,343

(22) Filed: Dec. 6, 2006

(51) Int. Cl. G05B 11/00

(52) U.S. Cl. 340/825; 340/686.1; 340/686.6

(57) ABSTRACT

A mobile device (e.g., a wearable device) may include a function module and a triggering arrangement. The triggering arrangement generates a signal in response to detecting a triggering condition. The signal activates the function module. The triggering condition includes at least one of (i) a change in proximity of the device relative to an object on which the mobile device performs an operation, (ii) an amount of force applied to the object by a user and (iii) an amount of force applied to at least a portion of the device.

### FIELD OF INVENTION

The present application generally relates to systems and methods for activating a mobile device.

### BACKGROUND INFORMATION

Mobile devices (e.g., bar code scanners, image-based scanners, RFID readers, radio transceivers, video recorders, etc.) are used in a multitude of situations for both personal and business purposes. These devices often utilize a manually operated triggering mechanism such as a pushable button, a sliding switch, a touch-panel, etc. The triggering mechanism requires a user to perform a triggering action in order to effect triggering. For example, if the triggering mechanism is thumb-activated, the triggering action may comprise moving a thumb from a resting position to a triggering position, then manually engaging the triggering mechanism. The triggering action may be time-intensive to perform. A user may be required to abandon or interrupt a task in order to perform the triggering action. If a device is being used extensively, this may result in substantial lost of productivity. In addition, the triggering action may be uncomfortable to perform. A movement associated with the triggering action may be unnatural and some users may not be able to perform the movement at all because of existing injuries or disabilities.

Accordingly, a need has developed for more user-friendly ways to operate mobile devices. This need is particularly prevalent in applications where a function of the mobile device is intimately related to performing an action. For example, the action may involve manipulating an object and using the device to perform an operation on the object. In such a situation, it would be desirable to enable the user to perform the action concurrently with a triggering action that initiates the operation. However, conventional triggering mechanisms require that the triggering action be performed separately.

### SUMMARY OF THE INVENTION

The present invention relates to a mobile device (e.g., a wearable device) that may include a function module and a triggering arrangement. The triggering arrangement generates a signal in response to detecting a triggering condition. The signal activates the function module. The triggering condition includes at least one of (i) a change in proximity of the device relative to an object on which the mobile device performs an operation, (ii) an amount of force applied to the object by a user and (iii) an amount of force applied to at least a portion of the device.

### BRIEF DESCRIPTION OF THE DRAWINGS

FIG. 1 shows a block diagram of an exemplary embodiment of a mobile device according to the present invention.

FIG. 2 shows an exemplary embodiment of a mobile device prior to triggering.

FIG. 3 shows the mobile device of FIG. 2 in an exemplary triggering position.

FIG. 4 shows an exemplary method for activating the device of FIG. 3 according to the present invention.

### DETAILED DESCRIPTION

The present invention may be further understood with reference to the following description and the appended drawings, wherein like elements are provided with the same reference numerals. The present invention relates to systems and methods for activating (e.g., triggering a function of) a mobile device. Various embodiments of the present invention will be described with reference to a wearable radio-frequency identification (“RFID”) reader. However, those skilled in the art will understand that the present invention may be implemented with any mobile device that is capable of being triggered.

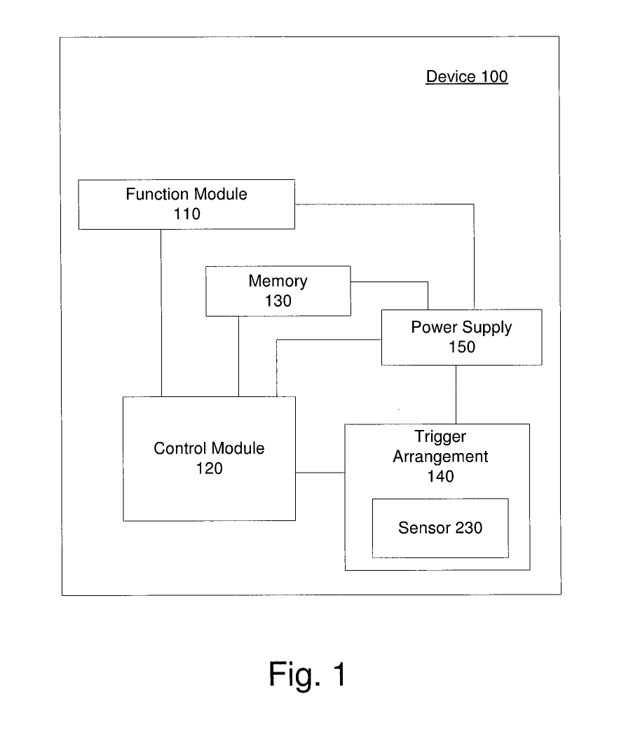

FIG. 1 shows a block diagram of an exemplary embodiment of a mobile device 100 according to the present invention. The device 100 may be used to implement any of the systems and methods for triggering that will be described below. As shown in FIG. 1, the device 100 may include a function module 110 communicatively coupled to a control module 120. The function module may include one or more electrical and/or mechanical components for executing a function of the device 100. For example, if the device 100 is an RFID reader, the function module 110 may include an RF transmitting and receiving arrangement for reading RF tags. The function module 110 may also include software components for controlling operation of the electrical/hardware components.

The control module 120 regulates the operation of the device 100 by facilitating communications between the various components of the device 100. The control module 120 may, for example, include a processor such as a microprocessor, an embedded controller, an application-specific integrated circuit, a programmable logic array, etc. The processor may perform data processing, execute instructions and direct a flow of data between devices coupled to the control module 120 (e.g., a memory 130 and a trigger arrangement 140). As explained below, the control module 120 may receive an input from the trigger arrangement 140 and in response, may activate the device 100 by instructing the function module 110 to perform a specific function (e.g., transmitting an RF query signal).

The memory 130 may be any storage medium capable of being read from and/or written to. The memory 130 may include any combination of volatile and/or nonvolatile memory (e.g., RAM, ROM, EPROM, Flash, etc.) The memory 130 may also include one or more storage disks such as a hard drive. In one embodiment, the memory 130 is a temporary memory in which data may be temporarily stored until it is transferred to a permanent storage location (e.g., uploaded to a personal computer). In another embodiment, the memory 130 may be a permanent memory comprising a database.

The trigger arrangement 140 may include any combination of hardware and/or software for detecting a user input and producing a corresponding output signal that is received by the control module 120. The trigger arrangement 140 may be directly or indirectly coupled to the control module 120. Direct coupling may comprise one or more wired connections between the trigger arrangement 140 and the control module 120. Indirect coupling may be achieved by any number of conventional coupling mechanisms, such as capacitive and inductive coupling, and relay switching. As shown in FIG. 1, the trigger arrangement 140 may include a sensor 230 for detecting the user input. The sensor 230 may be an electrical and/or a mechanical sensor and will be described in further detail below.

In an exemplary embodiment, the trigger arrangement 140 may be a passive triggering arrangement in which the user input may not be an action performed exclusively for the purpose of triggering the device 100. Thus, the trigger arrangement 140 is passive in that the user may not consciously intend to cause triggering. An example of a passive triggering action is picking up an object. The act of picking up the object may be associated with performing or preparing to perform a desired operation on the object. For example, the operation may be a data acquisition operation in which the device 100 reads an RFID tag located on the object. In contrast, an active triggering mechanism such as a mechanical switch involves a separate action that is independent of the desired operation.

The trigger arrangement 140 may also respond to active user input. That is, the user may intentionally perform a triggering action that constitutes a separate step in performing or preparing to perform the desired operation. The user may, for example, engage the trigger arrangement 140 by touching or pressing the sensor 230. Thus, triggering may occur in response to either indirect user interaction via the object or direct user interaction via the trigger arrangement 140.

The trigger arrangement 140 produces the output signal in response to the user input. The output signal may be analog or digital and may include a range of voltage and/or current values. In addition, the output signal may be either a continuous signal or an intermittent signal of fixed or variable duration. For example, if the output signal is the continuous signal, the control module 120 may periodically sample the output signal. If the output signal is the intermittent signal, it may announce itself to the control module 120.

The power supply 150 provides power to each component coupled thereto and may include a built-in power source (e.g., a battery) that may be rechargeable and/or replaceable. In addition or in alternative to the built-in source, the power supply 150 may include an arrangement for receiving an external power source (e.g., a AC-to-DC converter). As shown in FIG. 1, the power supply 150 may be coupled to each of the function module 110, the control module 120, the memory 130 and the trigger arrangement 140. Thus, the power supply 150 may provide power to each of these components.

Various embodiments of the present invention will now be described with reference to a strapped RFID reader. Strapped readers may be used in situations where it is desirable to operate a reader without requiring the user to hold it. This allows the user to use his hand for other purposes such as picking up an object, typing on a keyboard, writing, etc.

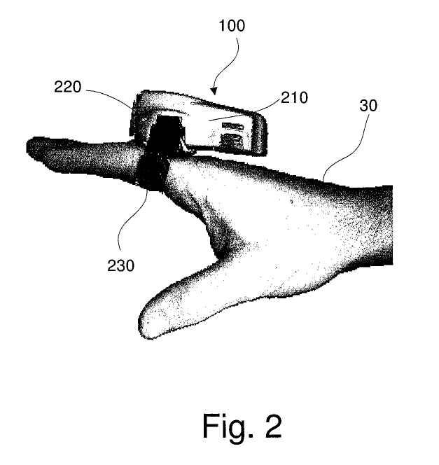

FIG. 2 shows an exemplary embodiment of the device 100 prior to triggering. The device 100 may be worn over one or more fingers of a hand 30 and may include a device housing 210 wearably coupled to the one or more fingers via a strap 220. The strap 220 may be formed of any suitably flexible material such as plastic, rubber or leather. Various attachment techniques may be used to adjust a fit of the strap 220. For example, a length of the strap 220 may be adjusted if the strap 220 is implemented with Velcro®, as a stretchable band, a belt, etc. Other attachment techniques may also be possible and will be apparent to one skilled in the art.

The sensor 230 is located on a triggering portion of the device 100. The triggering portion may be any portion that directly or indirectly engages the object and/or the user's body. In the exemplary embodiments described below, the triggering portion is the strap 220. Thus, the user input may comprise touching the sensor 230 to the object, making a fist, touching a finger to the sensor 230, etc. In other embodiments, the triggering portion may be located elsewhere, such as, for example, along a housing of the device 100. In the exemplary embodiment, the sensor 230 is located on an outer portion of the strap 220, facing a palm of the user. The sensor 230 may be embedded in the outer portion or, alternatively, may extend externally from the strap 220 (e.g., inward toward the palm or outward away from the palm). The sensor may be implemented using a pressure-sensitive technology. In one embodiment, the sensor may be a capacitive pressure sensor. In another embodiment, the sensor may be a magnetic or inductive pressure sensor. The sensor 230 may include mechanical or electrical components such as a strain gauge, a piezo-resistive strip, a contact switch, etc.

In an embodiment where the sensor 230 detects both active and passive user input, the sensor 230 may differentiate between the active and passive inputs. For example, active user input comprising a pressing with one or more fingers may produce a different pressure response compared to pressing the sensor 230 to the object (e.g., a different level of pressure, pressure at a different location, pressure of a different duration, etc.). The sensor 230 may also differentiate between different types of active and/or passive inputs such as, for example, a press of a single finger versus multiple fingers, grabbing the object versus pushing or tapping the object, etc. These differentiations may be used to prevent unintended triggering and/or enable triggering of additional functions.

Other technologies may be utilized to detect the user input. For example, the sensor 230 may be an optical sensor such as an infrared or laser-based sensor that measures the distance between the sensor 230 and the object. In another embodiment, the sensor 230 may be an electrical current sensor that measures impedance. When the user touches the object, a change in an impedance of the user's body and/or the strap 230 is detected. In addition, multiple sensors may be utilized to detect the user input. For example, a sensor may be located at each of a plurality of locations (e.g., below each finger) along the strap 220. The use of multiple sensors and/or multiple types of sensors may facilitate detection of the user input by eliminating false positives. In addition, multiple sensors may facilitate distinguishing between different types of user inputs.

A sensitivity of the sensor 230 may be customized according to the user. For example, if the sensor 230 is the pressure sensor, the user may select a desired pressure level as a threshold value or a range of threshold values for determining the triggering. Thus triggering may occur using any type of contact ranging from a light touch to a firm press. The light touch may activate a first trigger function, while the firm press may activate a second trigger function. If the sensor 230 is the optical sensor, the user may select a desired distance between the sensor 230 and the object. Further customizations may include combinations of multiple user inputs such as, for example, tapping the object twice (“double-tapping”). If multiple sensors are provided (e.g., dual or three-position triggers), the sensitivity of each of the multiple sensors may be customized. The user selections may be stored in a user profile on the device 100 (e.g., in the memory 130).

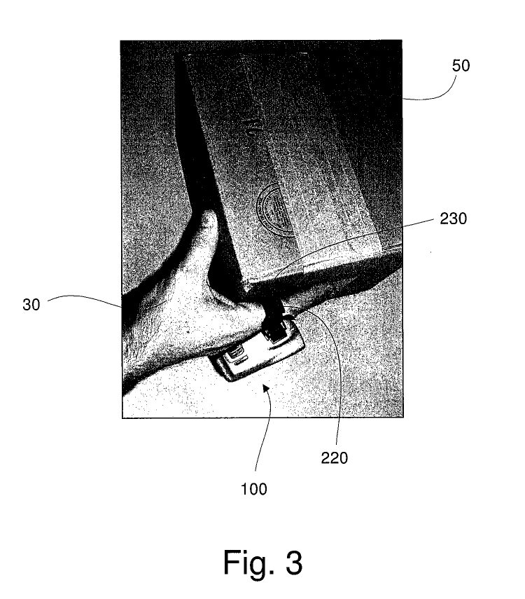

FIG. 3 shows an exemplary embodiment of the device 100 in an operational position according to the present invention. As shown in FIG. 3, the user has extended his hand to perform the user input (e.g., manipulating an object 50, touching the trigger arrangement 140, etc.). As a result of this user input, the sensor 230 is brought into proximity with the object 50 until contact is made. Thus, the contact and/or the change in proximity may comprise a triggering condition. One or more of these triggering conditions may cause triggering of the device 100. In addition, other triggering conditions such as internal events (e.g., a logical state of the device 100) may comprise additional triggering conditions used in combination with the triggering condition(s) to determine when triggering should occur. Thus, the device 100 may include a table or matrix of triggering conditions used to determine triggering of one of more functions thereof. That is, when specific combinations of one or more triggering conditions are detected in sequence or simultaneously, triggering may occur.

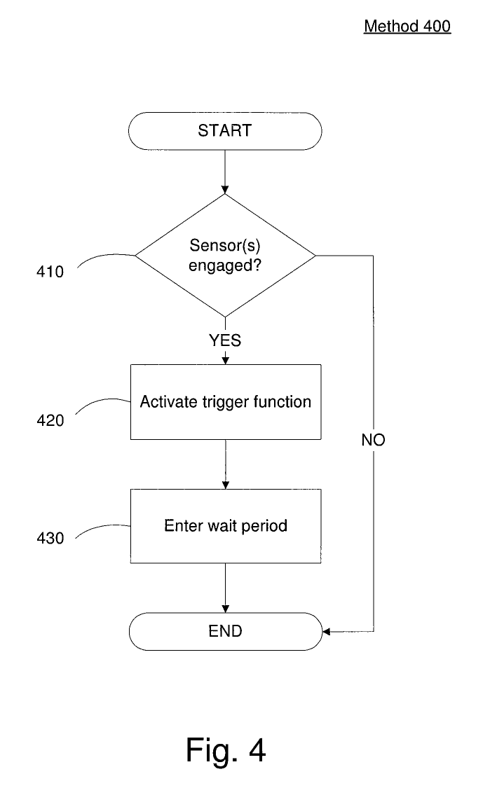

FIG. 4 shows an exemplary method 400 for activating the device 100 according to the present invention. The method 400 may be partially or entirely implemented in a control module of the device 100. In step 410, the device 100 determines whether one or more sensors (e.g., the sensor 230) are engaged (i.e., whether the triggering condition(s) is/are met). This may occur over a single time period (e.g., detecting a single triggering condition) or over multiple time periods (e.g., detecting multiple triggering conditions). In the exemplary embodiment, the sensor 230 is engaged when contact is made with the object 50.

In step 420, the sensor 230 is engaged and the device 100 activates a trigger function of the trigger arrangement 140. The trigger function produces the output signal in the manner previously described. In response, a function module (e.g., an RF reading arrangement) of the device 100 is activated. After the function module is activated, the device 100 may enter a wait period (step 430) in which the sensor 230 is placed in an idle mode or temporarily deactivated. The wait period prevents accidental retriggering of the function module resulting from continued contact with the object 50. This allows the user to complete the desired operation without causing retriggering. In some embodiments, the wait period may be user-programmable. After the wait period has elapsed, the sensor 230 is reactivated and may resume detection of the fingers 30. In other embodiments, the wait period may be defined as a predetermined time period that elapses after the sensor 230 is disengaged. Thus, as long as the triggering condition(s) continues to be met, the trigger function will not be reactivated.

As illustrated in the previously described embodiments, the present invention provides substantial benefits to the user. The triggering methods of the present invention enable the user to activate a mobile device without actively engaging a triggering mechanism. Because the triggering action is integrated with the desired operation, the user does not need to perform additional triggering actions. This results in significant time saving. Furthermore, any person capable of performing the triggering action can complete the desired operation. Because the triggering action is simple and natural to perform, these persons may include users who, because of repetitive stress injuries, arthritis, muscle cramping and other debilitating conditions, find conventional triggering arrangements difficult or uncomfortable to use.

Yet another advantage of the present invention is the ability to be customized to the user. For example, as previously discussed, a required pressure level may be adjusted to suit the user. Thus, users can customize the triggering conditions to match their own natural triggering habits. The device 100 may therefore be shared amongst any number of users while providing accurate triggering for each of the users.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A mobile device, comprising:
a function module; and
a triggering arrangement generating a signal in response to detecting a triggering condition, the signal activating the function module, the triggering condition including at least one of (i) a change in proximity of the device relative to an object on which the mobile device performs an operation, (ii) an amount of force applied to the object by a user and (iii) an amount of force applied to at least a portion of the device.

2. The device of claim 1, wherein the triggering arrangement includes at least one of a pressure-sensitive sensor, an impedance measuring sensor and an optical sensor.

3. The device of claim 2, wherein the sensor includes at least one of a strain gauge, a piezo-resistive sensor and a contact switch.

4. The device of claim 1, wherein a sensitivity of the triggering arrangement is user selectable.

5. The device of claim 4, wherein the sensitivity comprises a threshold value range including at least a first threshold value and a second threshold value.

6. The device of claim 5, wherein the first threshold value activates a first function and the second threshold value activates a second function.

7. The device of claim 1, wherein the triggering arrangement enters a predetermined wait period after generating the signal.

8. The device of claim 1, wherein the device is a wearable device.

9. The device of claim 1, wherein the device distinguishes a first input type from a second input type.

10. The device of claim 9, wherein the device distinguishes the first and second input types as a function of at least one of an amount of an applied force, a duration of the applied force and a location of the applied force.

11. The device of claim 9, wherein the first input type activates a first function of the function module and the second input type activates a second function of the function module.

12. A method, comprising:
detecting a triggering condition, the triggering condition including at least one of (i) a change in proximity of the device relative to an object on which the mobile device performs an operation, (ii) an amount of force applied to the object by a user and (iii) an amount of force applied to at least a portion of the device; and
generating a signal to activate a function of the device in response to detecting the triggering condition.

13. The method of claim 12, further comprising:
activating the function module.

14. The method of claim 12, wherein the triggering step is performed using a triggering arrangement which includes at least one of a pressure-sensitive sensor, an impedance measuring sensor and an optical sensor.

15. The method of claim 12, further comprising:
selecting a sensitivity with which the triggering condition is detected.

16. The method of claim 15, wherein the sensitivity comprises a threshold value range which includes at least a first threshold value and a second threshold value.

17. The method of claim 12, further comprising:
distinguishing a first input type from a second input type.

18. The method of claim 17, wherein the distinguishing step is performed as a function of at least one of an amount of an applied force, a duration of the applied force and a location of the applied force.

19. The method of claim 17, wherein the first input type activates a first function and the second input type activates a second function.

20. A mobile device, comprising:
a function means for performing a data capture function;
and
a triggering means for generating a signal to activate the function means in response to detecting a triggering condition, the triggering condition including at least one of (i) a change in proximity of the device relative to an object on which the mobile device performs an operation, (ii) an amount of force applied to the object by a user and (iii) an amount of force applied to at least a portion of the device.
